(19) United States
(12) Patent Application Publication
(10) Pub. No.: US 2005/0172949 A1
(43) Pub. Date: Aug. 11, 2005

(54) Apparatus for preparing food

(75) Inventors: Joel Reese Moore, New Braunfels, TX (US); Craig Alden Walther, Kyle, TX (US); Charles M. Olds, Martindale, TX (US); Brian Keith Yutzy, New Braunfels, TX (US); Mark Erby Hood, New Braunfels, TX (US); Robert Clifton Jones JR., Mountain City, TX (US); Edward R. Lee, Martindale, TX (US)

Correspondence Address: PRICE HENEVELD COOPER DEWITT & LITTON, LLP, 695 KENMOOR, S.E., P O BOX 2567, GRAND RAPIDS, MI, 49501, US

(73) Assignee: S.H. Leggitt Company

(21) Appl. No.: 11/054,223

(22) Filed: Feb. 9, 2005

Related U.S. Application Data
(60) Provisional application No. 60/570,179, filed on May 11, 2004.
(60) Provisional application No. 60/543,205, filed on Feb. 10, 2004.

(51) Int. Cl. A47J 27/026

(52) U.S. Cl. 126/39 G

(57) ABSTRACT

A cooking apparatus for preparing food includes a vessel, a burner, an electrically controllable valve, a thermocouple and a thermally actuated switch. The vessel is configured for containing a fluid and the burner is positioned for providing a gas flame to the vessel. The valve is coupled between the burner and a gas source and the thermocouple is positioned to sense a temperature of the flame provided by the burner. The thermally actuated switch is serially coupled between the valve and the thermocouple. The switch provides a conduction path between the valve and the thermocouple, when a temperature sensed by the thermal switch is less than a predetermined temperature. The switch is integrally mounted to the vessel to sense a temperature of the fluid contained within the vessel.

This application claims the benefit of U.S. Provisional Patent Application Ser. No. 60/570,179, entitled “APPARATUS FOR PREPARING FOOD,” which was filed May 11, 2004, and U.S. Provisional Patent Application Ser. No. 60/543,205, entitled “APPARATUS FOR PREPARING FOOD,” which was filed Feb. 10, 2004, both of which are hereby incorporated herein by reference in their entirety.

### BACKGROUND OF THE INVENTION

The present invention is generally directed to the preparation of food and, more specifically, to an apparatus for preparing food.

Many apparatuses for preparing food, such as turkey fryer appliances, have included a vessel, supported by a stand, and a burner. In such cooking apparatuses, a regulator and hose assembly have typically been connected between the burner and a gas source, e.g., a portable propane cylinder. In normal operation, a temperature of a fluid, e.g. a cooking oil, contained by the vessel has been monitored to maintain the fluid temperature at an appropriate cooking temperature, e.g., 350 degrees Fahrenheit. In order to avoid relatively long warm-up times, some prior art cooking apparatuses have included an adjustable propane regulator with the capability of providing a relatively high outlet pressure, e.g., a pressure of about 15 psi. When the regulator is adjusted to provide a relatively large flame from the burner, the fluid contained within the cooking vessel may be heated to a desired temperature in a relatively short period of time.

It should be appreciated that if the cooking apparatus or appliance is left unattended, while the burner is providing a relatively high flame to the vessel, the temperature of the fluid within the vessel may continue to climb until the fluid reaches its ignition temperature, which is approximately 650 degrees Fahrenheit for a typical cooking oil. To prevent ignition of the fluid, some prior art appliances have required an operator to place a probe into the fluid contained within the vessel, through a top of the vessel. The probe then monitors the fluid temperature and causes operation of the appliance to be terminated when the temperature exceeds a desired temperature. However, when an operator fails to place or maintain the probe in the fluid within the vessel, such safety features are ineffective.

What is needed is a cooking apparatus for preparing food that includes a safety feature that is configured to prevent a fluid, contained within a vessel of the cooking apparatus, from reaching an ignition temperature. It would be desirable for the safety feature to be designed such that it cannot be readily rendered ineffective.

### SUMMARY OF THE INVENTION

One embodiment of the present invention is directed to a cooking apparatus for preparing food that includes a vessel, a burner, an electrically controllable valve, a thermocouple and a thermally actuated switch. The vessel is configured for containing a fluid and the burner is positioned for providing a gas flame to the vessel. The valve is coupled between the burner and a gas source and the thermocouple is positioned to sense a temperature of the flame provided by the burner. The thermally actuated switch is serially coupled between the valve and the thermocouple. The switch provides a conduction path between the valve and the thermocouple, when a temperature sensed by the switch is less than a predetermined temperature. The switch is integrally mounted to the vessel to sense a temperature of the fluid contained within the vessel.

According to another aspect of the invention, the cooking apparatus includes a stand for supporting the vessel. According to still another aspect of the present invention, the apparatus includes a gas regulator coupled between the gas source and the valve. According to various embodiments, the predetermined temperature is an ignition temperature of the fluid, which may be a cooking oil. According to a further aspect of the invention, the thermally actuated switch is positioned within a center of a heatsink that is integrated along an outer surface of the vessel, with the heatsink including a cavity that receives a portion of the fluid, when the fluid is contained within the vessel. In one embodiment, the heatsink has a horseshoe configuration.

According to still another aspect of the present invention, the thermocouple is positioned through a main body of the burner and is cooled by a gas-air mixture carried by the burner and a hot junction of the thermocouple is positioned in the gas flame.

These and other features, advantages and objects of the present invention will be further understood and appreciated by those skilled in the art by reference to the following specification, claims and appended drawings.

### BRIEF DESCRIPTION OF THE DRAWINGS

FIG. 1 is a perspective view of a cooking apparatus for preparing food, constructed according to one embodiment of the present invention;

FIG. 2 is a perspective view of the cooking apparatus of FIG. 1, with a shroud removed;

FIG. 3 is a perspective view of a vessel for containing fluid that includes a heatsink that is integrated along an outer surface of the vessel, approximate whose center is located a thermally actuated switch;

FIG. 4 is an interior view of the vessel of FIG. 3, depicting a horseshoe-shaped aperture, which allows a fluid contained within the vessel to enter the integrated heatsink;

FIG. 5 is an electrical block diagram of the electrical components of the cooking apparatus configured according to one aspect of the present invention;

FIG. 6 is a perspective view of a vessel having a heatsink assembly constructed according to another embodiment of the present invention;

FIG. 7A is a side view of the vessel of FIG. 6;

FIG. 7B is a cross-section of the vessel of FIG. 7A along the lines A-A;

FIG. 8A is a perspective view of an exemplary burner including a thermocouple, which has been mounted through the burner according to another embodiment of the present invention; and

FIG. 8B is a partial cross-sectional view of the burner of FIG. 8A, further depicting the location of the thermocouple with respect to the burner.

### DETAILED DESCRIPTION OF PREFERRED EMBODIMENTS

According to the present invention, a cooking apparatus for preparing food, e.g., a turkey, is designed to prevent a fluid, e.g., a cooking oil, contained within a vessel of the cooking apparatus, from reaching its ignition temperature. According to one aspect of the present invention, gas flow to a burner of the cooking apparatus is automatically stopped if the fluid temperature exceeds a predetermined temperature, e.g., a normal cooking temperature. In one embodiment of the present invention, the cooking apparatus includes a vessel, a burner, an electrically controllable valve, a thermocouple and a thermally actuated switch. The vessel is designed to receive and contain a fluid and an article of food, e.g., a turkey, and the burner is positioned for providing a gas flame to the vessel to heat the fluid and cook the article of food. The thermocouple is positioned to sense a temperature of the flame provided by the burner. The thermocouple may be, for example, a model T400 manufactured and made commercially available by Orkli.

In operation, heat produced by the flame causes a voltage to be produced by the thermocouple. The thermally actuated switch is serially coupled between the valve and the thermocouple and provides, when closed, a conduction path between the thermocouple and the valve. In this manner, a current is provided to the valve to maintain the valve in an open position, allowing gas to flow from a gas source, via a gas regulator, through the valve and into the burner. The thermally actuated switch, for example, a thermostat switch, is mounted within the integrated heatsink on the cooking vessel. The thermostat switch is a normally closed switch and, as such, allows current to flow to the valve during normal operation. If and when the temperature in the switch climbs above a pre-set temperature, the thermostat switch opens, disrupting current flow, and the valve closes, shutting off gas flow to the burner.

In a typical operation, the electrically controllable valve of the cooking apparatus is held open manually until a flame provided by the burner heats the thermocouple to an appropriate temperature. Following an overheat event, the valve is closed and the gas is shut off to the burner. The valve is then required to be held open manually, to relight the burner of the cooking apparatus. The valve may be one of several valves manufactured and made commercially available by TPA Metals and Machinery.

According to one aspect of the invention, the cooking apparatus employs a unique mounting of the thermostat into the heatsink, which is integrated into a wall of the cooking vessel. As is discussed further below, the heatsink is formed to allow a fluid contained within the vessel to flow into the heatsink and, thus, essentially surround a portion of the thermostat switch. As such, the temperature of the switch closely follows the actual temperature of the fluid within the vessel, ensuring a relatively consistent performance. As is discussed above, prior art devices have required an operator to place a probe into the oil through a top of a vessel, e.g., a cooking pot, which can render prior safety devices ineffective if the probe is left out of the fluid contained within the vessel.

It should be appreciated that in a cooking apparatus configured according to the present invention, the thermostat switch cannot readily be bypassed as the thermostat switch is required to complete the circuit from the thermocouple to the valve in order for the valve to supply gas to the burner. That is, if the thermostat switch is not electrically connected, the valve will not stay open automatically and the burner of the cooking apparatus will fail to operate when an operator no longer manually actuates the valve. The thermostat switch may be, for example, a model C thermostat switch manufactured and made commercially available by Portage Electric Products.

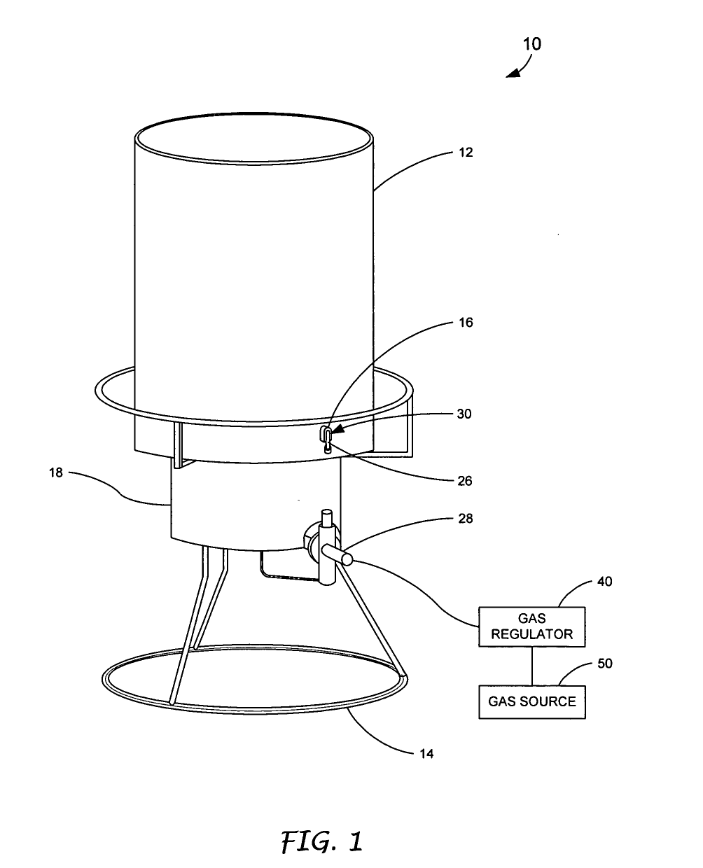

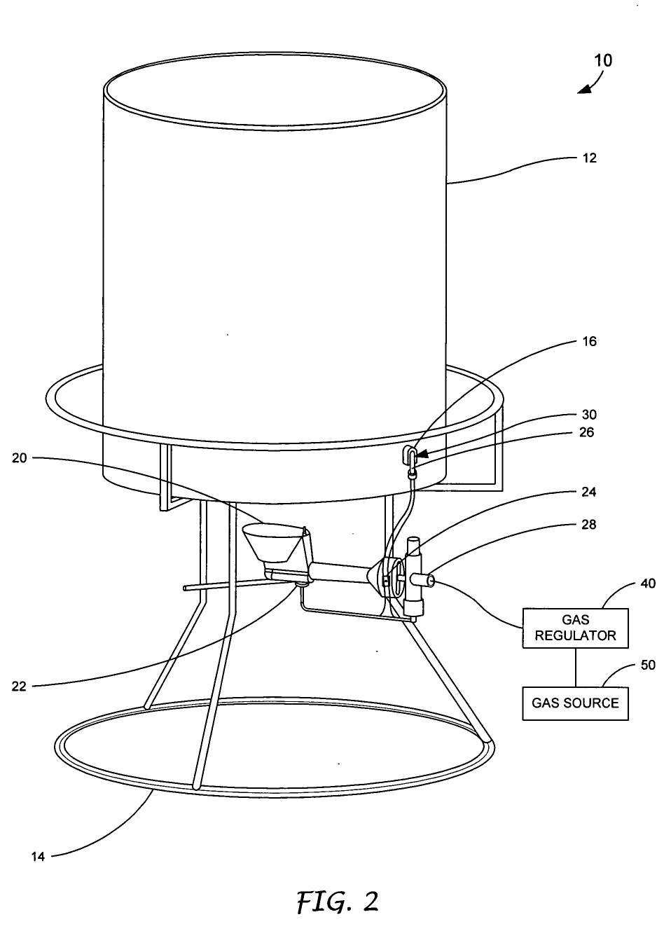

With reference to FIGS. 1 and 2, a cooking apparatus 10 includes a vessel 12 for containing a fluid. The vessel 12 includes an integrated heatsink 16, which includes a center aperture 30, which receives a thermally actuated switch 26. An electrically controllable valve 28 is coupled to a gas regulator 40, which receives gas from a gas source 50. As shown in FIG. 1, a shroud 18 protects an operator from a flame provided by a burner 20, which is coupled to and receives gas from the valve 28. As is better shown in FIG. 2, the burner 20 is positioned underneath the vessel 12 and the vessel 12 is positioned on a stand 14, which may also support the burner 20. The valve 28 is mechanically coupled to the burner 20 and electrically coupled to thermocouple 22, which is positioned to provide an indication of the temperature of the flame provided by the burner 20. The thermally actuated switch 26 is located within the aperture 30 of the heatsink 16 and is electrically coupled, by a connector 24, in series with the thermocouple 22 and the valve 28.

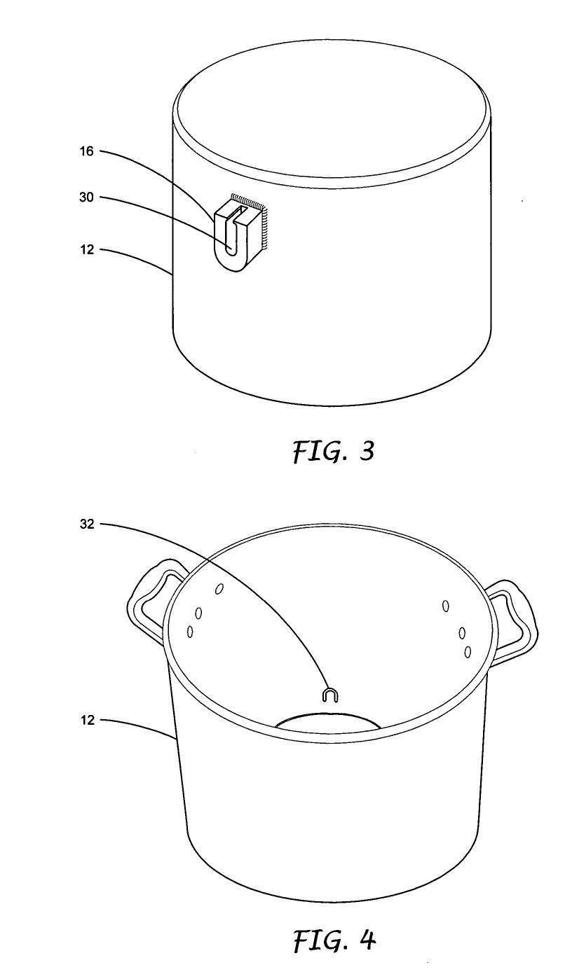

FIG. 3 further depicts the vessel 12 and the integrated heatsink 16, which is integrated in a lower wall portion of the vessel 12. The heatsink 16 includes the center aperture 30, which is configured to receive a thermostat switch. As is best shown in FIG. 4, the vessel 12 includes an inner aperture 32, configured as a horseshoe, which allows a fluid contained within the vessel 12 to enter the heatsink 16 and, thus, to facilitate improved heat transfer between the fluid and the thermally actuated switch 26.

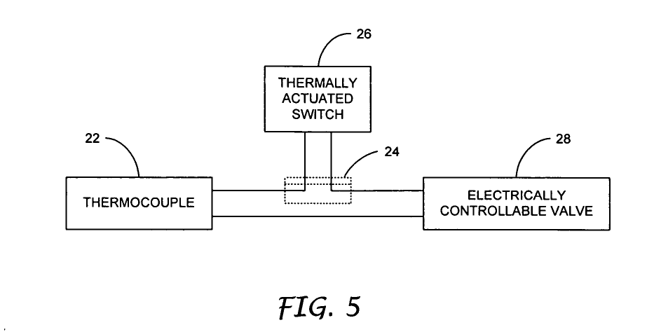

With reference to FIG. 5, the thermally actuated switch 26 is serially coupled between the thermocouple 22 and the electrically controllable valve 28. As previously mentioned, the connector 24 connects the thermally actuated switch 26 between the thermocouple 22 and the electrically controllable valve 28. As is mentioned above, the valve 28 of the cooking apparatus will not operate in an automatic mode, unless the thermally actuated switch 26 is coupled between the thermocouple 22 and the valve 28. This feature prevents circumvention of the safety feature by simply disconnecting the thermally actuated switch connector 24.

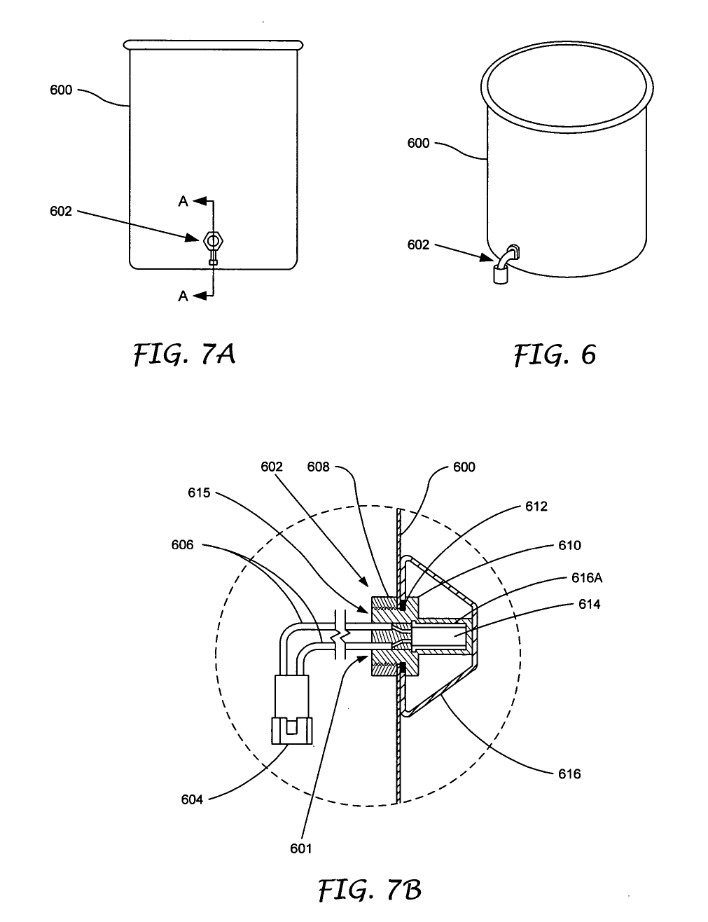

According to another embodiment of the present invention, a cooking vessel for a cooking apparatus includes a heatsink assembly that is positioned through a wall of the vessel. With reference to FIG. 6, a cooking vessel 600 includes a heatsink assembly 602 installed through a wall of the vessel 600 at an appropriate height. It should be appreciated that the installation height of the heatsink assembly 602, within the wall of the vessel 600, may be generally dictated by the amount of fluid that would typically be held within the vessel 600, during cooking operations.

With reference to FIG. 7A, a side view of the vessel 600, with the heatsink assembly 602 installed therein, is depicted. As is better shown in FIG. 7B, the heatsink assembly 602 includes a thermally actuated switch 614 installed within an aperture 615 of heatsink 610. The thermally actuated switch 614 may be retained within the aperture 615 of the heatsink 610 by a thermal epoxy 616A. As is shown, a threaded portion of the heatsink 610 extends through an aperture 601 in the wall of the vessel 600. A nut 608 engages the threads of the heatsink 610 and, in combination with a seal 612, is utilized to prevent leakage of a fluid contained within the vessel 600 through the aperture 601. The thermally actuated switch 614 is coupled by conductors 606, to a connector 604, which is compatible with the connector 24 of FIG. 5. The connector 604 allows the thermally actuated switch 614 to be coupled between the thermocouple 22 and the electrically controllable valve 28. A shield 616 may be integrated with the heatsink 610, to protect the heatsink 610 from damage, e.g., damage induced by fry baskets inserted within the vessel 600. It should be appreciated that positioning the heatsink 610 internal to the cooking vessel 600 generally allows the thermally actuated switch 614 to more closely follow a cooking temperature of a fluid contained within the vessel 600 and, thus, generally provides more consistent performance.

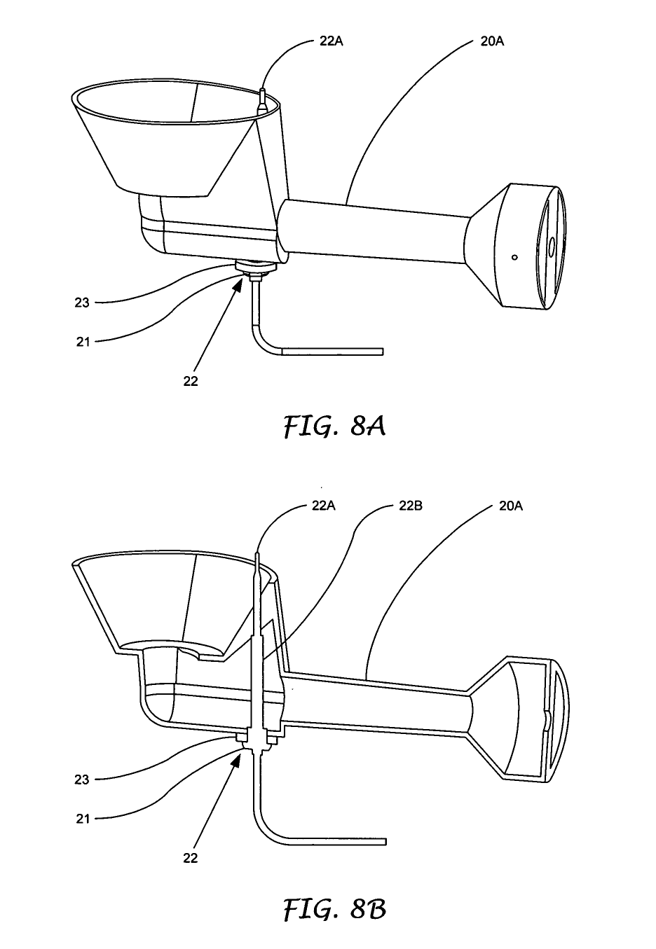

According to another aspect of the present invention, and with reference to FIG. 8A, a burner 20A includes a thermocouple 22 mounted through an aperture 21 in the burner 20A with a portion of the thermocouple, i.e., a tip 22A or hot junction of the thermocouple 22, extending through the top of the burner 20A and positioned such that the tip 22A is located in a flame associated with the burner 20A. It should be appreciated that a typical appliance thermocouple has a hot junction that must be exposed to a flame and a cold junction that must stay relatively cool, as compared to the hot junction, for the thermocouple to function properly. As is also shown in FIG. 8A, a seat 23 seals the aperture 21 and the burner 20A to the thermocouple 22. As is better shown in FIG. 8B, cold junction 22B of the thermocouple 22 is located within a main body of the burner 20A. Locating the cold junction 22B of the thermocouple 22 within the main body of the burner 20A is advantageous in that gas and air mixture that flows through the burner 20A provides a cooling affect to the cold junction 22B, which keeps the cold junction 22B cool and maintains the functionality of the thermocouple 22.

Accordingly, a cooking apparatus has been described herein that advantageously provides for monitoring temperatures of a fluid contained within a vessel of the cooking apparatus and discontinuing providing a flame to the vessel in the event the temperature of the fluid exceeds a desired temperature. The cooking apparatus also advantageously stops gas flow in the case of a flame-out attributable to wind or low gas flow.

The above description is considered that of the preferred embodiments only. Modifications of the invention will occur to those skilled in the art and to those who make or use the invention. Therefore, it is understood that the embodiments shown in the drawings and described above are merely for illustrative purposes and not intended to limit the scope of the invention, which is defined by the following claims as interpreted according to the principles of patent law, including the doctrine of equivalents.

1. A cooking apparatus for preparing food, comprising:
a vessel for containing a fluid;
a burner positioned for providing a gas flame to the vessel;
an electrically controllable valve coupled between the burner and a gas source;
a thermocouple positioned to sense a temperature of the flame provided by the burner; and
a thermally actuated switch serially coupled between the valve and the thermocouple, wherein the switch provides a conduction path between the valve and the thermocouple when a temperature sensed by the switch is less than a predetermined temperature, and wherein the switch is integrally mounted to the vessel to sense a temperature of the fluid when contained within the vessel.

2. The apparatus of claim 1, wherein the thermocouple is positioned through a main body of the burner, and wherein a cold junction of the thermocouple is cooled by a gas-air mixture carried by the burner and a hot junction of the thermocouple is positioned in the gas flame.

3. The apparatus of claim 1, further comprising:
a stand for supporting the vessel.

4. The apparatus of claim 1, further comprising:
a gas regulator coupled between the gas source and the valve.

5. The apparatus of claim 1, wherein the predetermined temperature is an ignition temperature of the fluid.

6. The apparatus of claim 1, wherein the fluid is a cooking oil.

7. The apparatus of claim 1, wherein the switch is positioned within a center of a heatsink that is integrated along an outer surface of the vessel, and wherein the heatsink includes a cavity that receives a portion of the fluid when the fluid is contained within the vessel.

8. The apparatus of claim 7, wherein the heatsink has a horseshoe configuration.

9. The apparatus of claim 1, wherein the switch is positioned within a center of a heatsink that is positioned through an aperture formed in a wall of the vessel.

10. A cooking apparatus for preparing food, comprising:
a vessel for containing a fluid, wherein the vessel includes a heatsink integrated along an outer surface of the vessel, and wherein the heatsink includes a cavity that receives a portion of the fluid when the fluid is contained within the vessel;
a burner positioned for providing a gas flame to the vessel;
an electrically controllable valve coupled between the burner and a gas source;
a thermocouple positioned to sense a temperature of the flame provided by the burner; and
a thermally actuated switch serially coupled between the valve and the thermocouple, wherein the switch provides a conduction path between the valve and the thermocouple when a temperature sensed by the switch is less than a predetermined temperature, and wherein the switch is positioned within a center of the heatsink.

11. The apparatus of claim 10, wherein the thermocouple is positioned through a main body of the burner, and wherein a cold junction of the thermocouple is cooled by a gas-air mixture carried by the burner and a hot junction of the thermocouple is positioned in the gas flame.

12. The apparatus of claim 10, further comprising:
a stand for supporting the vessel.

13. The apparatus of claim 10, further comprising:
a gas regulator coupled between the gas source and the valve.

14. The apparatus of claim 10, wherein the predetermined temperature is an ignition temperature of the fluid.

15. The apparatus of claim 10, wherein the fluid is a cooking oil.

16. The apparatus of claim 10, wherein the heatsink has a horseshoe configuration.

17. The apparatus of claim 10, wherein the heatsink is positioned through an aperture formed in a wall of the vessel.

18. A cooking apparatus for preparing food, comprising:
a vessel for containing a fluid;
a burner positioned for providing a gas flame to the vessel;
an electrically controllable valve coupled between the burner and a gas source;
a thermocouple positioned to sense a temperature of the flame provided by the burner;
a thermally actuated switch serially coupled between the valve and the thermocouple, wherein the switch provides a conduction path between the valve and the thermocouple when a temperature sensed by the switch is less than a predetermined temperature, and wherein the switch is integrally mounted to the vessel; and
a stand for supporting the vessel.

19. The apparatus of claim 18, wherein the thermocouple is positioned through a main body of the burner, and wherein a cold junction of the thermocouple is cooled by a gas-air mixture carried by the burner and a hot junction of the thermocouple is positioned in the gas flame.

20. The apparatus of claim 18, further comprising:
a gas regulator coupled between the gas source and the valve.

21. The apparatus of claim 18, wherein the predetermined temperature is an ignition temperature of the fluid.

22. The apparatus of claim 18, wherein the fluid is a cooking oil.

23. The apparatus of claim 18, wherein the switch is positioned within a center of a heatsink that is integrated along an outer surface of the vessel, and wherein the heatsink includes a cavity that receives a portion of the fluid when the fluid is contained within the vessel.

24. The apparatus of claim 23, wherein the heatsink has a horseshoe configuration.

25. The apparatus of claim 18, wherein the switch is positioned within a center of a heatsink that is positioned through an aperture formed in a wall of the vessel.

26. A cooking apparatus for preparing food, comprising:
a burner positioned for providing a gas flame to the vessel;
an electrically controllable valve coupled between the burner and a gas source; and
a thermocouple positioned to sense a temperature of the flame provided by the burner.

27. The apparatus of claim 26, wherein the thermocouple is positioned through a main body of the burner, and wherein a cold junction of the thermocouple is cooled by a gas-air mixture carried by the burner and a hot junction of the thermocouple is positioned in the gas flame.

28. The apparatus of claim 26, further comprising:
a vessel for containing a fluid; and
a thermally actuated switch serially coupled between the valve and the thermocouple, wherein the switch provides a conduction path between the valve and the thermocouple when a temperature sensed by the switch is less than a predetermined temperature, and wherein the switch is integrally mounted to the vessel to sense a temperature of the fluid when contained within the vessel.

29. The apparatus of claim 28, further comprising:
a stand for supporting the vessel.

30. The apparatus of claim 26, further comprising:
a gas regulator coupled between the gas source and the valve.

31. The apparatus of claim 28, wherein the predetermined temperature is an ignition temperature of the fluid.

32. The apparatus of claim 28, wherein the fluid is a cooking oil.

33. The apparatus of claim 28, wherein the switch is positioned within a center of a heatsink that is integrated along an outer surface of the vessel, and wherein the heatsink includes a cavity that receives a portion of the fluid when the fluid is contained within the vessel.

34. The apparatus of claim 33, wherein the heatsink has a horseshoe configuration.
